(19) United States
(12) Patent Application Publication
(10) Pub. No.: US 2014/0193201 A1
(43) Pub. Date: Jul. 10, 2014

(54) River bottom siphon for hydro-electric generation and irrigation

(71) Applicant: David William Stauffer, Portland, OR (US)

(72) Inventor: David William Stauffer, Portland, OR (US)

(21) Appl. No.: 13/734,978

(22) Filed: Jan. 6, 2013

(51) Int. Cl. F16L 1/16; E02B 3/00

(52) U.S. Cl. CPC F16L 1/16; E02B 3/00
USPC 405/75; 405/154.1

(57) ABSTRACT

The invention is David Stauffer's river bottom siphon and hydroelectricity generator for a pollution-free hydroelectric energy generator using a submerged river pipeline and gravity for the delivery of fresh river-water for agriculture and drinking through a fabricated ecosystem to ease the problems of global warming, rising ocean levels, flooding, drought, pollution, depletion of the ozone layer, the blockage of fish migration by dams, and loss of rain forests, grazing land, and agricultural land through a system of large river-bottom pipelines to transfer the abundant supply of fresh water on the bottoms of the Columbia and Mississippi Rivers and, eventually, the Nile, Tigris, Rhine, Yellow, and all other rivers throughout the world to lands in need of fresh water (no really, I'm not joking) invention.

### RELATED APPLICATIONS

There are no related applications.

### FEDERALLY-SPONSORED RESEARCH

This invention was not invented through federally sponsored research or development.

### JOINT RESEARCH AGREEMENT

There is no joint research agreement.

### SEQUENCE LISTING

There is no reference to a “Sequence Listing”.

### BACKGROUND OF THE INVENTION

It is common knowledge that large electricity generators produce an almost free large current of electricity from dammed reservoirs. The standard method of operation is that a large reservoir of water is created by damming a river and then allowing a tunnel or pipeline, at the bottom of the dam, of water to flow past turbines on generators to turn those turbines of the hydroelectric power generator and create electricity. Inventor Stauffer has invented an alternative method by which to create the pipeline of water to turn the turbines of the hydroelectric power generator, which does not require a dam nor a reservoir of water behind the dam. Instead, the powerful flow of water can be created by gravity in a submerged pipeline that flows from a higher elevation to a lower elevation.

An existing example of a flow of water from the upper part of a dammed reservoir to a lower level is the “glory hole” of the Monticello Dam in California. That hole's suction of water from the upper level is an example of a large pipeline that drops 14,400 cubic feet of water per second down the “glory hole” pipeline. Such a forceful current of water could easily turn the turbines of a hydroelectric generator.

It should be noted that the water that will be sent to lands in need of water is only the fresh water on the bottom of any particular river. That water has never been used by any of the land owners that have riparian rights to the river water. Instead, all the riparian owners have allowed all that fresh water to flow all the way down the river to the river mouth where it mingles with the salt water of the ocean, increases the level of the ocean, and is lost as fresh water. Because the claimed pipeline simply contains this river-bottom water that presently flows down the river and is lost in the ocean, the level of water in the river is not decreased and all riparian rights are unaffected. Because the pipeline is on the river-bottom, the level of the water remains the same and ship and boat traffic on the river is unaffected.

When California has previously requested that Oregon divert the Columbia River so that it flows down to the dry lands in California, Oregon has firmly rejected the idea. There is no diversion of the Columbia River, or any other river, in this patent idea. All of the Columbia River waters will flow down the river to the mouth of the river at the Pacific Ocean, just as they always have. The idea of this patent is only to capture the fresh water at the bottom of the river that would normally flow into the salt water of the ocean and be lost to the ocean's salt water. Instead of losing that water—owned by no riparian rights owners—this invention captures that water and transfers it to dry lands in need of fresh water.

It should also be noted that these same siphon and garden-hose principals could also be used to divert water at the river sources—which is an entirely different plan than these present claims. For example, the Shoshone River in Wyoming is dammed by the Shoshone Dam, near Cody Wyo., which has an elevation of about 5,000 feet. After the dam, the Shoshone River flows into a ravine that is about 50 meters below the town of Cody, Wyo., and below a plateau of non-agricultural sage brush land that stretches for miles around Cody. It would be possible to siphon the entire Shoshone River to this non-agricultural sage brush land and make it suitable for growing timber or crops, or for grazing land for buffalo, cows, or sheep. However, such a siphon attempt would probably be met with years of litigation by the owners of the downstream riparian rights to the Shoshone River water. Although the siphon principles could be used upstream to divert entire rivers, the present claims intentionally disregard all those possibilities in favor of using only the fresh river water that travels all the way to the ocean, is wasted, and is never claimed by any owners of riparian rights.

In Oregon, there is a perceived problem that the farmers in eastern Oregon—in Morrow and Umatilla counties—would like Columbia River water diverted to Morrow and Umatilla counties to create irrigated farmland, which might create 10,000 jobs in agriculture. However, other interests oppose any diversion of the Columbia River; they want to maintain a high level of cold water so that migrating fish can migrate upstream for spawning. To solve this shortage of water, one embodiment of this invention is to put a 10-meter-diameter plastic pipeline at the bottom of the Columbia River (on top of the river bed), starting about George, Wash. (wherever the bottom of the river is about 100 meters above sea level). At George, the water level of the river would not change because the pipeline would be above the riverbed level and the only water that would enter the pipeline is the river-bottom water that is going down the river to the ocean anyway. The water on the top of the river—above and around the pipeline—is sufficient for all downstream riparian rights of the Columbia River. No river water will be diverted because only the normal water at the bottom of the river is confined in a watertight plastic pipeline all the way to where the river empties into the ocean. Once the submerged pipeline gets to sea level, at Astoria, Oreg., the river-bottom water in the pipeline would normally flow into the Pacific Ocean, co-mingle with the salt water, and be lost as fresh water. Instead of losing that water to the Pacific Ocean, the submerged pipeline, at Astoria, Oreg., would make a water-tight u-turn and head back up the river to Umatilla and Morrow counties, and all other locations that are at a lower sea level than the higher, starting elevation of 100 meters above sea level at about George, Wash. In fact, the water could be siphoned 10 meters higher than 100 meters if necessary. The water could also be pushed higher by the 2-3 knot current of the water that enters the pipeline at George, Wash., and would continue to push the water all through the pipeline. The water would flow back up the river from Astoria, Oreg., because the pipeline would act like a big water tank, or garden hose, that stretches all the way from George, Wash., to Astoria, and back to Umatilla and Morrow counties. In fact, because the pipeline returning from Astoria would be as large as the 10-meter diameter pipeline going down the river, the returning pipeline would actually raise the water level of the river by the volume of the water in the returning pipeline. This increase in water level would benefit the fish runs when the river level is low. In the spring, when the river is flooding, the pipeline should have powered paddles on it to paddle the water downstream and speed the flood waters down the river in order to maintain non-flood water levels. In similar manner, all the dry farmlands of eastern Washington and Oregon can be irrigated—and hundreds of thousands of jobs will be created.

In fact, this patent contemplates that controversial areas, such as the Rogue River in Oregon, will be able to get water upstream and inland to areas that need water for irrigation if one of the pipelines from the Columbia River should go south along the Oregon coast and then turn inland at the mouth of the Rogue River. That Columbia River water could then go up the Rogue River and deliver the water to areas that need irrigation water. The Rogue River dams that formerly had supplied water for irrigation are now breached so that there are no longer reservoirs for irrigation. This patent contemplates that irrigation water would again be available upstream in the Rogue River.

### The Science of Siphons

The science of siphons and how they work is well settled. Wikipedia has the following explanation under the word “siphon”:

The word siphon is sometimes used to refer to a wide variety of devices that involve the flow of liquids through tubes but in the narrower sense it refers specifically to a tube in an inverted U shape which causes a liquid to flow uphill, above the surface of the reservoir, without pumps, powered by the fall of the liquid as it flows down the tube under the pull of gravity, and is discharged at a level lower than the surface of the reservoir. Note that while the siphon must touch the liquid in the (upper) reservoir (the surface of the liquid must be above the intake opening), it need not touch the liquid in the lower reservoir and indeed there need not be a lower reservoir—liquid can discharge into mid-air.

In practical siphons, atmospheric pressure pushes the liquid up the tube into the region of reduced pressure at the top of the tube in the same way as a barometer, and indeed the maximum height of a siphon is the same as the height of a barometer, because they operate by the same mechanism. The reduced pressure is caused by liquid falling on the exit side.

When both ends of a siphon are at atmospheric pressure, liquid flows from high to low. However, if the lower end is pressurized, liquid can flow from low to high, as in siphon coffee. While in everyday siphons, atmospheric pressure is the driving mechanism, in specialized circumstances other mechanisms can work—in the laboratory, some siphons have been demonstrated to work in a vacuum, indicating the tensile strength of the liquid is contributing to the operation of siphons at very low pressures. Most familiar siphons have water as a fluid, though mercury is often used in experiments, and other fluids such as organic liquids or even carbon dioxide can be siphoned.

### History

Egyptian reliefs from 1500 BC depict siphons used to extract liquids from large storage jars. There is physical evidence for the use of siphons by Greek engineers in the 3rd century BC at Pergamon. Hero of Alexandria wrote extensively about siphons in the treatise Pneumatica. In the 9th century, the Banu Musa brothers invented a double-concentric siphon, which they described in their Book of Ingenious Devices. The edition edited by Hill includes an Analysis of the double-concentric siphon.

Siphons were studied further in the 17th century, in the context of suction pumps (and the recently developed vacuum pumps), particularly with an eye to understanding the maximum height of pumps (and siphons) and the apparent vacuum at the top of early barometers. This was initially explained by Galileo via the theory of horror vacui (“nature abhors a vacuum”), which dates to Aristotle, and which Galileo restated as resintenza del vacuo, but this was subsequently disproved by later workers, notably Evangellista Torricelli and Blaise Pascal.

Specifically, Pascal demonstrated that siphons work via atmospheric pressure (as Torricelli had advocated), not via horror vacui, via the following experiment. Two beakers of mercury are placed in a large container, at different heights. The beakers are connected with a three-way tube: a regular siphon (U-shaped tube), with an additional tube extending upward from the hook in the tube: one end of the tube goes down into each beaker (as in a normal siphon), while the third end faces upward, and is open to the air. The large container is slowly filled with water (the tube remains open to the air): as water goes into the container, the weight of the water forces the mercury up into the tube (water being denser hence heavier than air)—as the water level increases, the level of mercury rises because the pressure increases—and once the mercury enters the top of the siphon, the mercury flows from the higher beaker to the lower, as in a standard siphon. As the mercury had been open to the air at all time, there was never a vacuum—it was instead the pressure of the water.

### Operation

There are two main issues in the operation of a siphon:
why liquid flows from the higher reservoir to the lower reservoir, which is basic; and
why liquid flows up the siphon, which is subtler.

The first issue is basic: liquid flows from the higher level to the lower level because the lower location has lower potential energy—water flows downhill. This is independent of the particular connection—liquids will also flow from higher to lower if there is a direct path (a canal), or if there is a tube that goes below the reservoirs (an “inverse” siphon), and these do not depend on siphon effect. Note that this is due to different heights (moving in the direction of gravity), not due to differences in atmospheric pressure at different heights (in fact, lower locations will, all else equal, have higher atmospheric pressure, due to a longer column of air above).

The second issue, why liquid flows up, is due primarily to atmospheric pressure (in ordinary siphons), and is the same mechanism as in suction pumps, vacuum pumps, and barometers, and can be replicated in the simple experiment of placing a straw in water, capping the top, and pulling it up (leaving the bottom tip submerged).

### Theory

A siphon works because gravity pulling down on the taller column of liquid causes reduced pressure at the top of the siphon (formally, hydrostatic pressure). This reduced pressure means gravity pulling down on the shorter column of liquid is not sufficient to keep the liquid stationary so it flows from the upper reservoir, up and over the top of the siphon.

Looking at FIG. 2, one can look at how the hydrostatic pressure varies through the siphon, considering in turn the vertical tube from the top reservoir, the vertical tube from the bottom reservoir, and the horizontal tube connecting them (assuming a U-shape). At liquid level in the top reservoir, the liquid is under atmospheric pressure, and as one goes up the siphon, the hydrostatic pressure decreases since the weight of atmospheric pressure pushing the water up is counterbalanced by the column of water in the siphon pushing down (until one reaches the maximum height of a barometer/siphon, at which point the liquid cannot be pushed higher)—the hydrostatic pressure at the top of the tube is then lower than atmospheric pressure by an amount proportional to the height of the tube. Doing the same analysis on the tube rising from the lower reservoir yields the pressure at the top of that (vertical) tube; this pressure is lower because the tube is longer (there is more water pushing down), and requires that the lower reservoir is lower than the upper reservoir, or more generally that the discharge outlet simply be lower than the surface of the upper reservoir. Considering now the horizontal tube connecting them, one sees that the pressure at the top of the tube from the top reservoir is higher (since less water is being lifted), while the pressure at the top of the tube from the bottom reservoir is lower (since more water is being lifted), and since liquids move from high pressure to low pressure, the liquid flows across the horizontal tube from the top basin to the bottom basin. Note that the liquid is under positive pressure (compression) throughout the tube, not tension.

When the column of liquid is allowed to fall, in FIG. 2, from C down to D, liquid in the upper reservoir will flow up to B and over the top. No liquid tensile strength is needed.

An occasional misunderstanding of siphons is that they rely on the tensile strength of the liquid to pull the liquid up and over the rise. While water has been found to have a great deal of tensile strength in some experiments (such as with the z-tube), and siphons in vacuum rely on such cohesion, common siphons can easily be demonstrated to need no liquid tensile strength at all to function. Furthermore, since common siphons operate at positive pressures throughout the siphon, there is no contribution from liquid tensile strength, because the molecules are actually repelling each other in order to resist the pressure, rather than pulling on each other. To demonstrate, the longer lower leg of a common siphon can be plugged at the bottom and filled almost to the crest with liquid, leaving the top and the shorter upper leg completely dry and containing only air. When the plug is removed and the liquid in the longer lower leg is allowed to fall, the liquid in the upper reservoir will then typically sweep the air bubble down and out of the tube. The apparatus will then continue to operate as a siphon. As there is no contact between the liquid on either side of the siphon at the beginning of this experiment, there can be no cohesion between the liquid molecules to pull the liquid over the rise. Another simple demonstration that liquid tensile strength isn't needed in the siphon is to simply introduce a bubble into the siphon during operation. The bubble can be large enough to entirely disconnect the liquids in the tube before and after it, defeating any liquid tensile strength, and yet if the bubble isn't too big, the siphon will continue to operate with little change.

The uphill flow of water in a siphon doesn't violate the principle of continuity because the mass of water entering the tube and flowing upwards is equal to the mass of water flowing downwards and leaving the tube. A siphon doesn't violate the principle of conservation of energy because the loss of gravitational potential energy as liquid flows from the upper reservoir to the lower reservoir equals the work done in overcoming fluid friction as the liquid flows through the tube. Once started, a siphon requires no additional energy to keep the liquid flowing up and out of the reservoir. The siphon will draw liquid out of the reservoir until the level falls below the intake, allowing air or other surrounding gas to break the siphon, or until the outlet of the siphon equals the level of the reservoir, whichever comes first.

In addition to atmospheric pressure, the density of the liquid, and gravity, the maximum height of the crest is limited by the vapor pressure of the liquid. When the pressure within the liquid drops to below the liquid's vapor pressure, tiny vapor bubbles can begin to form at the high point and the siphon effect will end. This effect depends on how efficiently the liquid can nucleate bubbles; in the absence of impurities or rough surfaces to act as easy nucleation sites for bubbles, siphons can temporarily exceed their standard maximum height during the extended time it takes bubbles to nucleate. For water at standard atmospheric pressure, the maximum siphon height is approximately 10 m (32 feet); for mercury it is 76 cm (30 inches), which is the definition of standard pressure. This equals the maximum height of a suction pump, which operates by the same principle. The ratio of heights (about 13.6) equals the ratio of densities of water and mercury (at a given temperature), since the column of water (resp. mercury) is balancing with the column of air yielding atmospheric pressure, and indeed maximum height is (neglecting vapor pressure and velocity of liquid) inversely proportional to density of liquid.

### Chain Analogy

### The Chain Model is a Flawed Analogy to the Operation of a Siphon in Ordinary Conditions

A simplified but misleading conceptual model of a siphon is that it is like a chain hanging over a pulley with one end of the chain piled on a higher surface than the other (See FIG. 3). Since the length of chain on the shorter side is lighter than the length of chain on the taller side, the chain will move up around the pulley and down towards the lower surface.

There are a number of problems with the chain model of a siphon, and understanding these differences helps to explain the actual workings of siphons. The first is in practical siphons, the liquid is pushed through the siphon, not pulled. That is, under most practical circumstances, dissolved gases, vapor pressure, and (sometimes) lack of adhesion with tube walls, conspire to render the tensile strength within the liquid ineffective for siphoning. Thus, unlike a chain which has significant tensile strength, liquids usually have little tensile strength under typical siphon conditions, and therefore the liquid on the rising side cannot be pulled up, in the way the chain is pulled up on the rising side.

A related problem is that siphons have a maximum height (for water siphons at standard atmospheric pressure, about 10 meters), as this is the limit to how high atmospheric pressure will push the water, but the chain model has no such limit—or rather is instead limited by how strong the links are (above a certain height, the chain links could not support the weight of the hanging chain and the links would snap), corresponding to tensile strength of the liquid, which is not the cause of maximum height in siphons.

In FIG. 4, even the falling lighter lower leg from C to D can cause the liquid of the heavier upper leg to flow up and over into the lower reservoir

A further problem with the chain model of the siphon is that siphons work by a gradient of hydrostatic pressure within the siphon, not by absolute differences of weight on either side. The weight of liquid on the up side of the siphon can be greater than the liquid on the down side, yet the siphon can still function. For example, if the tube from the upper reservoir to the top of the siphon has a much larger diameter than the section of tube from the lower reservoir to the top of the siphon, the shorter upper section of the siphon may have a much larger weight of liquid in it, yet the siphon can function normally—this is because hydrostatic pressure depends on height (reduces as one goes up a column), but does not depend on diameter of the tube.

Despite these shortcomings, in some situations siphons do function in the absence of atmospheric pressure and via tensile strength and in these situations the chain model can be instructive. Further, in other settings water transport does occur via tension, most significantly in transpirational pull in the xylem of vascular plants.

### Practical Requirements

A plain tube can be used as a siphon. An external pump has to be applied to start the liquid flowing and prime the siphon. This can be a human mouth. This is sometimes done with any leak-free hose to siphon gasoline from a motor vehicle's gasoline tank to an external tank. (Siphoning gasoline by mouth often results in the accidental swallowing of gasoline, which is quite poisonous, or aspirating it into the lungs, which can cause death or lung damage). If the tube is flooded with liquid before part of the tube is raised over the intermediate high point and care is taken to keep the tube flooded while it is being raised, no pump is required. Devices sold as siphons come with a siphon pump to start the siphon process. When applying a siphon to any application it is important that the piping be as closely sized to the requirement as possible. Using piping of too great a diameter and then throttling the flow using valves or constrictive piping appears to increase the effect of previously cited concerns over gases or vapor collecting in the crest which serve to break the vacuum. Once the vacuum is reduced the siphon effect is lost.

Reducing the size of pipe used closer to requirements appears to reduce this effect and creates a more functional siphon that does not require constant re-priming and restarting. In this respect, where the requirement is to match a flow into a container with a flow out of said container (to maintain a constant level in a pond fed by a stream, for example) it would be preferable to utilize two or three smaller separate parallel pipes that can be started as required rather than attempting to use a single large pipe and attempting to throttle it.

In 2012, the Manual of Patent Examining Procedures (MPEP) was revised as follows:

### Patent Revision of 2012

### MPEP 2173.05 States:

### 2173.05(j) Old Combination

A Claim should not be Rejected on the Ground of Old Combination

With the passage of the 1952 Patent Act, the courts and the Board have taken the view that a rejection based on the principle of old combination is NO LONGER VALID. Claims should be considered proper so long as they comply with the provisions of 35 U.S.C. 112, second paragraph.

A rejection on the basis of old combination was based on the principle applied in Lincoln Engineering Co. v. Stewart-Warner Corp., 303 U.S. 545, 37 USPQ 1 (1938). The principle was that an inventor who made an improvement or contribution to but one element of a generally old combination, should not be able to obtain a patent on the entire combination including the new and improved element. A rejection required the citation of a single reference which broadly disclosed a combination of the claimed elements functionally cooperating in substantially the same manner to produce substantially the same results as that of the claimed combination. The case of In re Hall, 208 F.2d 370, 100 USPQ 46 (CCPA 1953) illustrates an application of this principle.

The court pointed out in In re*>Bernhart<, 417 F.2d 1395, 163 USPQ 611 (CCPA 1969) that the statutory language (particularly point out and distinctly claim) is the only proper basis for an old combination rejection, and in applying the rejection, that language determines what an applicant has a right and obligation to do. A majority opinion of the Board of Appeals held that Congress removed the underlying rationale of Lincoln Engineering in the 1952 Patent Act, and thereby effectively legislated that decision out of existence. Ex parte Barber, 187 USPQ 244 (Bd. App. 1974). Finally, the Court of Appeals for the Federal Circuit, in Radio Steel and Mfg. Co. v. MTD Products, Inc., 731 F.2d 840, 221 USPQ 657 (Fed. Cir. 1984), followed the *>Bernhart<case, and ruled that a claim was not invalid under Lincoln Engineering because the claim complied with the requirements of 35 U.S.C. 112, second paragraph. Accordingly, a claim should not be rejected on the ground of old combination.

At first glance, it appears that most of the improvements or new contributions of inventor Stauffer are elements of an old combination of a dam and a hydroelectric plant. Indeed, the science of siphons, pipelines, and hydroelectric generators is so well-established that all those elements are common knowledge. Together, they are an “old combination” of the type specified in MPEP 2173.05. However, it is novel to arrange that “old combination” so that, in one embodiment, the pipeline (which is really about 10 individual pipelines) is submerged on the bottom of a river (such as the Columbia River) and forms a water-tight siphon that starts at a high elevation (about 100 meters above sea level)(Point A in FIG. 1) that goes down the river and then is siphoned up over dams on the Columbia River (Points B and C in FIG. 1), and then continues flowing downstream through the siphon to the mouth of the Columbia River (Point B in FIG. 1), and then continues south (without allowing the mixing of the pipeline's fresh water with the ocean's salt water), below sea level, along the Oregon and Washington coastal waters to the mouths of various rivers in Oregon, California (such as the San Joaquin River) (Point E in FIG. 1) and Mexico, and then, without pumps to pump the water, the pipeline continues up those rivers to higher elevations (such as 99 meters above sea level) (Point F in FIG. 1) and, if needed, is siphoned an additional 10 meters in height (Point G in FIG. 1), and then, like a garden hose, squirts the Washington State river-bottom water on the dry inland communities of Oregon, California (such as the California Aqueducts) (Point H in FIG. 1) and Mexico that need fresh water for drinking, irrigation and fire suppression. Theoretically, the pipeline could create reservoirs in Death Valley, so that the Death Valley area could cease being a “Death Valley” and become an agricultural area or forest. It is also novel to put hydroelectric-generating turbines on that pipeline about (in one embodiment) every kilometer or so, to create non-polluting sources of electricity all along the pipeline for the towns and communities along the Columbia River, and the Oregon, Washington, and Mexico coasts. It is also novel to use external power to increase the spin of the pipeline's turbines and use them as paddle wheels to send flood waters down the river in a faster current to control flood waters by getting the flood waters down the river faster. It is also novel to use this same hydroelectric power generation system to replace the hydroelectric generation of dams along the river so that the dams can be breached and so that fish, such as salmon, can again freely migrate up the Columbia River to spawn. It is also novel that, if the river water is placed in pipelines, the water that people drink will be less likely to be contaminated by upriver sources of sewage, toxic wastes, or the nuclear waste at the Hanford nuclear reservation. Using the above pipeline, those “old combination” elements can be combined in a novel manner to generate electricity without pollution, and the energy input that is required in other existing electricity generators—such as a coal-fired electricity generators (like the one at Boardman, Oreg.). Such energy generation will reduce carbon emissions into the atmosphere, and lessen depletion of the ozone layer, lessen global warming, and help to decrease the rising levels of the oceans.

MPEP 2173.05(v) states: “Mere Function of Machine. Process or method claims are not subject to rejection by U.S. Patent and Trademark Office examiners under 35 U.S.C. 112, second paragraph, solely on the ground that they define the inherent function of a disclosed machine or apparatus. In reTarczy-Hornoch, 397 F.2d 856, 158 USPQ 141 (CCPA 1968). The court in Tarczy-Hornoch held that a process claim, otherwise patentable, should not be rejected merely because the application of which it is part discloses apparatus which will inherently carry out the recited steps.”

During the examination, the examiner might erroneously suggest that there is nothing that is not previously general knowledge. The examiner might argue that, even though no other scientist in human history has suggested that Stauffer's invention was possible, siphons, hydroelectric generators, and pipelines are common knowledge and that it would be obvious to a person skilled in the art of siphons, hydroelectric generators, and pipelines to make inventor Stauffer's invention—that Stauffer's invention is a “mere function of machines” that are already known. Inventor Stauffer submits that:
1. It has never been obvious to anyone to submerge a siphon pipeline at the bottom of a river and have it travel thousands of miles, through an ocean, and then go up other rivers and over small mountains to deliver fresh water to inland areas that need water for drinking, irrigation and fire suppression.
2. It has never been obvious to anyone to build pollution-free hydro-electric-generating plants every kilometer or so along such a submerged pipeline to provide electrical energy to towns and communities along the river banks and along the ocean shores.
3. Even if the submerged pipeline and the submerged generator operated as the “mere function” of those machines, MPEP 2173.05(v) would allow inventor Stauffer to obtain a patent on the invention.

The Wikipedia explanation, above, discloses the unpatented common knowledge, state of the prior art on siphons. A siphon and a pipeline are unpatented common knowledge, as is the generator with turbines turned by a flow of water through a tube, as in hydroelectric dams everywhere. However, inventor Stauffer claims the following as being novel aspects of those old combinations:
1. Inventor Stauffer creates the gravity-driven water flow for the hydroelectric generators with a submerged pipeline rather than with a dam and reservoir of water behind the dam. Inventor Stauffer creates the flow of water by starting the pipeline by catching the river's water current in a submerged pipeline in river water that is high (in one embodiment, around 100 meters above sea level) so that the water in the pipeline will flow downhill along the river bottom to sea level, and then below sea level. At the mouth of a coastal river, the pipeline will turn so that it goes up the coastal river and over the hills that feed the coastal river. The pipeline will go over coastal hill pass river beds below the hills, and down the other side of the hills to a level that is below the original 100 meters above sea level. The water will go over the coastal mountains by two actions: the “garden hose” pressure of the river's water current, and a siphon action for no more than 10 meters above the 100 meters above sea level. By siphon action, the water will flow a thousand miles and up and over coastal hills (through valley riverbeds) to provide water to inland, drought-stricken communities and farmlands, such as Death Valley, Calif.
2. The electricity generator turbines, in one embodiment, will be capable of being powered so that, in addition to creating electricity by being pushed by the flow of water in the pipeline, such turbines will also be capable of pushing the river water out of the pipeline to relieve flooding when the river is flooded, by increasing the speed of the water through the pipeline, and lowering the flood water level in the river.

### VIEWS OF THE DRAWINGS

The FIG. 1 is an example of one theoretical embodiment of the pipeline in one river—the Columbia River in America. Hopefully, most large rivers of the world will be able to also use this invention. In FIG. 1, the horizontal axis (not drawn to any scale) represents theoretical distance from the beginning of the pipeline, and its vertical axis represents the height of the pipeline in terms of meters above or below sea level. The pipeline starts at point A where, in one embodiment, the river bottom's height is 100 meters above sea level (at George, Wash.?). The submerged pipeline will then continue down the Columbia River to the dam at The Dalles, Oregon (Point B in FIG. 1), where it will then be siphoned or “garden-hosed” over the dam to the bottom of the river on the other side of the dam. The submerged pipeline will then continue down the Columbia River to the Bonneville dam (Point C in FIG. 1), where it will then be siphoned or “garden-hosed” over the dam to the bottom of the river on the other side of the dam. It will then flow down the bottom of the Columbia River to point D (at about sea level) at the mouth of the Columbia River at Astoria, Oreg. It will then proceed south along the shallow Oregon and California coastal waters, below sea level. At the mouth of the San Joaquin River (point E), one of the ten pipelines will turn inland and proceed along the bottom of the San Joaquin River up to a higher level that can be as high as 100 meters above sea level (point F), plus 10 meters (Point G—the maximum height that water can be siphoned) to go over the California coastal hills (through river passes) to the other side of the hills where it can be discharged into, in one embodiment, an array of irrigation aqueducts, pipes, and ditches at any level below 300 meters above sea level (Point H in FIG. 1) (and as low as Death Valley, which is below sea level).

FIGS. 2, 3 and 4, which explain how siphons work, have previously been explained.

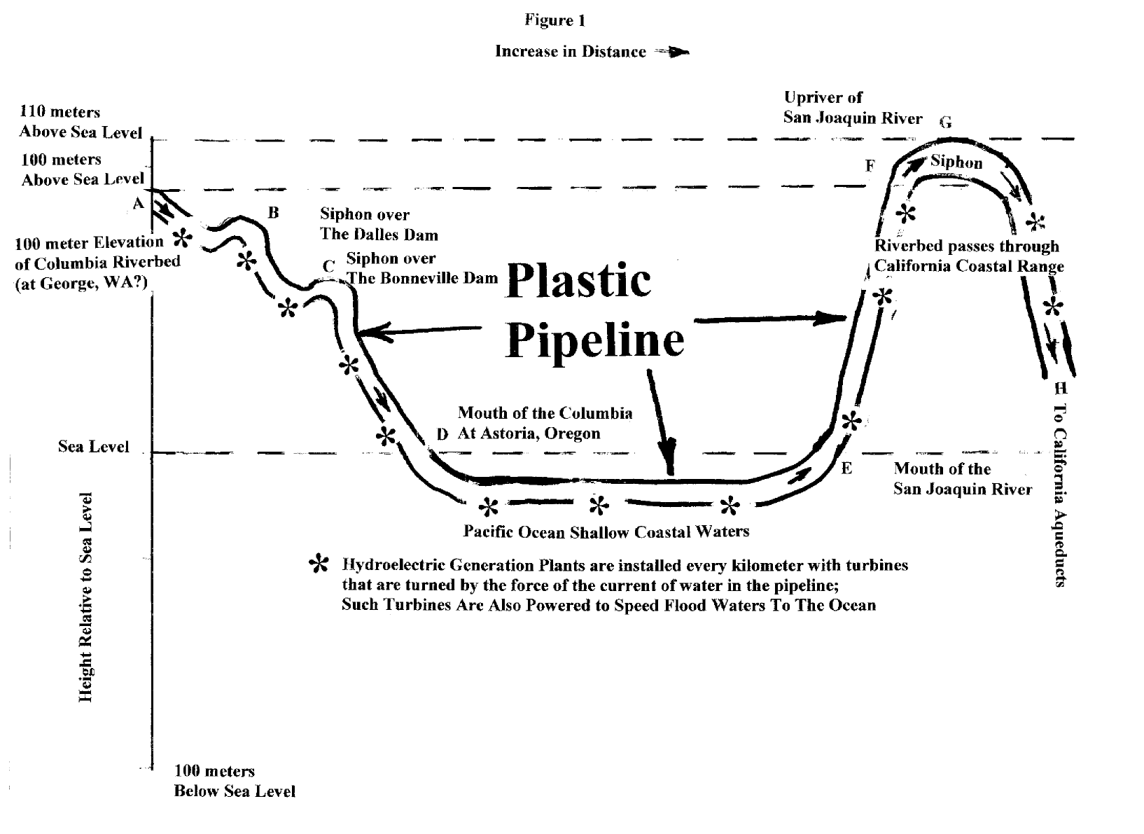

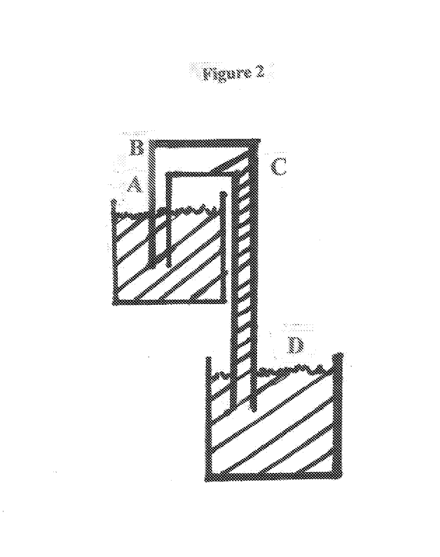

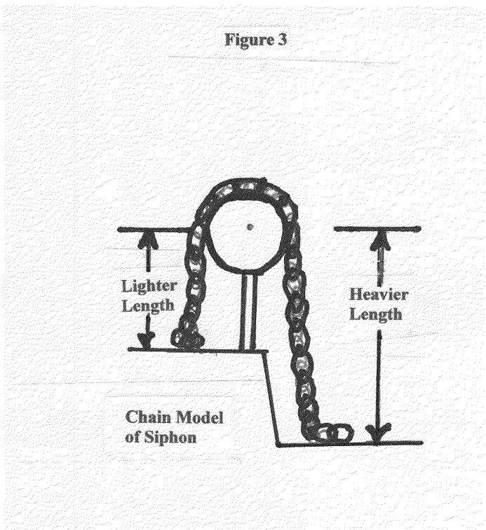

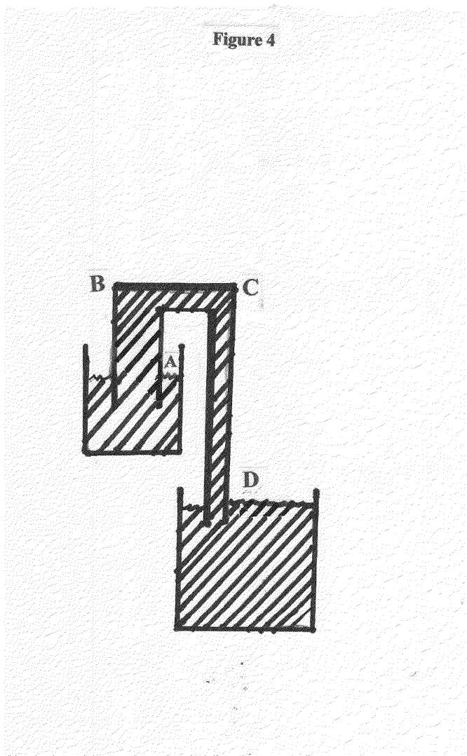

### DETAILED DESCRIPTION OF THE INVENTION

Inventor Stauffer perceives the need to solve the following problems:
1. The world needs to lower carbon emissions from the creation of electricity (such as the burning of coal),
2. The world needs to stop the depletion of the ozone layer around the poles,
3. The world needs to decrease global warming,
4. The world needs to decrease the levels of its oceans,
5. The world needs to decrease violent storms and droughts that may result from global warming,
6. The world needs to get water to land areas that suffer from drought,
7. The world needs to take the water that floods some land areas and send it to other areas that experience drought,
8. The world needs to transfer water flows from flood areas to drought areas through river waterbeds rather than trying to get permission from landowners to build large pipelines that might break and cause environmental damage,
9. The world needs to find an alternative source of hydroelectric energy so that dams may be breached and traditional fish migrations for the purpose of spawning upstream may be restored.

Inventor Stauffer notes that the Columbia, Mississippi, and other rivers have an excess of river-bottom fresh water that flows to the oceans and is wasted when it mixes with the salt water of the ocean, and contributes to the rising level of the oceans, and there are regions of the country, and the world, that need fresh water for agriculture and drinking Inventor Stauffer's invention is to devise a system of water siphon pipelines and huge “garden hoses” that deliver water from the higher level of river-bottoms to deserts and other areas in need of water, through the scientific principles of gravity, siphons, and “garden-hose” water pressure.

### BRIEF SUMMARY OF THE INVENTION

David W. Stauffer recognizes the need for a submerged, river-bottom hydroelectric plant invention for use in the Columbia River and in the Mississippi River (and eventually, in all other rivers of the world) in order to irrigate inland lands, control floods, and provide pollution-free electricity.

### SPECIFICATIONS

David W. Stauffer recognizes the need for a submerged, river-bottom hydroelectric plant invention for use in the Columbia River and in the Mississippi River (and eventually, in all other rivers of the world) as follows:
1. On the Columbia River, build a submerged (to a depth that is 2 meters below the deepest allowable depth of any boat or ship at the lowest historical river level) air-tight and water-tight plastic pipeline siphon that consists of about 10 individual pipelines that are about 10 meters in diameter, and, together, about 100 meters wide and 10 meters tall, and that run along the bottom of the Columbia River where the bottom of the river is about 100 meters above sea level (at George, Wash.?) to the Pacific Ocean, and then along the shoreline of the Oregon and California coastal waters (in waters that are 20 meters deep) to southern California, so that each pipeline can deliver fresh water to various agriculture regions, cities and towns in Oregon, California, and Mexico by continuing the pipeline from the coastal ocean waters up through various rivers, such as the Rogue river, the Sacramento river, and the San Joaquin river so that fresh water can be used inland, and possibly, for the California Aqueduct system, for drinking, irrigation and fire suppression. When the pipeline encounters a dam—such as the Bonneville dam—siphon the pipeline up over the top of the dam (no higher than 10 meters) and down to the water beyond the dam's spillway to continue the flow of water down the pipeline. The 110 meter level is the level of the highest mountain riverbed in California or Oregon or Mexico that the water can be siphoned over in order to irrigate the inland agricultural land, and provide water for irrigation, drinking, and fire suppression, to inland communities.
2. On the Mississippi River, build a submerged (to a depth that is 2 meters below the deepest allowable depth of any boat or ship at the lowest historical river level) air-tight and water-tight plastic pipeline siphon that consists of about 10 individual pipelines that are about 10 meters in diameter, and, together, about 100 meters wide and 10 meters tall, and that run from a point where the bottom of the Mississippi River is about 100 meters above sea level to the bottom of the Texas and Mexico coastal waters to Arizona, New Mexico, Texas and Mexico, with numerous branches to deliver fresh water to various agriculture regions, cities and towns in the southern United States and Mexico, by continuing the plastic pipeline from the coastal ocean waters up various rivers, such as the Rio Grande, so that water can be used inland for drinking, irrigation and fire suppression. When the pipeline encounters a dam, run the pipeline up over the top of the dam (no higher than 10 meters) and down to the water beyond the dam's spillway to continue the flow of water down the pipeline. The 110 meter level is the level of the highest riverbed in Texas or Mexico that the water can be siphoned over in order to irrigate the inland agricultural land, and provide fresh water for irrigation, drinking, and fire suppression to inland communities.
3. On both the Columbia and Mississippi river pipelines, and on other suitable rivers, install submerged hydroelectric generation plants about every kilometer to generate electricity by turbines run by the water that flows through the pipeline by the force of gravity, for the various agriculture regions, cities and towns along the pipeline routes. The turbines of the hydroelectric plants will also have a power supply that can convert them into paddlewheels to speed the flow of water down the river so that all floods will be controlled by sending the flood waters down the siphon pipeline faster than the normal speed of the current of the river.
4. The above plan requires no carbon emissions, so the environmental impact statement will show that there is no effect on the environment. Any break or leak in the pipeline will result in fresh water flowing into the other part of the fresh water river, so there will be no water erosion or environmental impact from breaks or leaks in any one of the pipeline siphons. Because the entire pipeline is at the bottom of a river, a break in the pipeline will only allow the pipeline water to flow into the river water around the pipelines. In addition, the pipeline will not decrease the level of the river, so barges will be able to travel the river as they always have. Since the water pressure on the outside of the pipeline will be the same as the water pressure on the inside of the pipe, it can be positioned so that the pipeline will not have to be very thick or heavy, so it is not directly laying on the river bottom or ocean bottom.
5. Use this invention in every big river around the world to bring water and electricity to the whole world—particularly to deserts and dry areas that are not presently able to grow crops, or allow for animal grazing, or grow bushes and trees. Such areas could include Palestine, Israel, the Sahara Desert, Saudi Arabia, and Kuwait. With proper irrigation and water for drinking and fire suppression, those desert areas could become forest, farmland, and grazing areas suitable for human habitation. The trees and plants that would grow in those regions would convert the carbon dioxide in the earth's atmosphere to oxygen and lower the depletion of the ozone layer, decreasing global warming and the accompanying rise of ocean levels. In addition, the northern and southern areas of the earth that have been made warmer by global warming can be inhabited and planted with forests, crops, and grazing land.
6. The bountiful supply of hydroelectric energy can replace the burning of fossil fuels to create electricity, and air pollution will be decreased.
7. When all the rivers are spreading a lot of their water to water-starved lands that are inland instead of to the oceans, less water will flow into the oceans, and the effect of elevated ocean water levels, due to global warming, will be decreased.
8. Because of global warming, most areas will have longer planting seasons, and there will be more crops per year harvested, so that more people can be fed, and more trees planted to turn carbon dioxide into oxygen.
9. The pipeline will irrigate areas that are deserts or barren land so that numerous fruit trees can be planted that will grow and provide fruit; the leaves of the trees will turn the carbon dioxide in the air into clean oxygen.
10. After it is proven that there is sufficient electrical energy that is supplied by the many submerged hydroelectric plants, the dams along the rivers can be breached or circumvented so that fish migrations up the rivers for spawning can be restored to their pre-dam levels, and there will be a plentiful source of fish for food.

1. The fabrication of a submerged (to a depth that is 2 meters below the deepest allowable depth of any boat or ship at the lowest historical river level) air-tight and water-tight plastic pipeline siphon that consists, in one embodiment, of about 10 individual pipelines that are about 10 meters in diameter, and, together, about 100 meters wide and 10 meters tall, and that run along the bottom of the river where the river is about 100 meters above sea level, to the ocean, and then along the ocean shoreline in waters that are 20 meters deep through the coastal waters to points where the water can be diverted to go up the mouths of rivers to elevations that are under 100 meters above sea level and deliver water to dry lands inland from the ocean coast for drinking, irrigation and fire suppression. When the pipeline encounters a dam, siphon the pipeline up (no higher than 10 meters) over the top of the dam and down to the water beyond the dam's spillway to continue the flow of water down the pipeline. The 110-meter level is the level of the highest riverbed of the hill or mountain that the water can be siphoned over in order to irrigate the inland agricultural land, and provide water for irrigation, drinking, and fire suppression to inland communities.

2. On the same river, and on other suitable rivers, install submerged hydroelectric generation plants about, in one embodiment, every kilometer to generate electricity by turbines run by the water that flows through the pipeline by the force of gravity, for the various agriculture regions, cities and towns along the pipeline routes. The turbines of the hydroelectric plants will also have a power supply that can convert them into paddlewheels to speed the flow of water down the river so that all floods of the river will be controlled by sending the flood waters down the siphon pipeline faster than the normal speed of the current of the river.

3. This invention can be used in every big river around the world to bring water and electricity to the whole world—particularly to deserts and dry areas that are not presently able to grow crops, or allow for animal grazing, or growing bushes and trees with leaves to turn carbon dioxide into oxygen.
